(19) United States
(12) Patent Application Publication
(10) Pub. No.: US 2015/0110335 A1
(43) Pub. Date: Apr. 23, 2015

(54) Integrated Speaker Assembly

(71) Applicant: Knowles Electronics, LLC, Itasca, IL (US)

(72) Inventors: Vladimir Telemaque, Bartlett, IL (US); Michael Schoffmann, Baden (AT)

(21) Appl. No.: 14/507,152

(22) Filed: Oct. 6, 2014

Related U.S. Application Data
(60) Provisional application No. 61/889,254, filed on Oct. 10, 2013.

(51) Int. Cl. H04R 9/04; H04R 31/00

(52) U.S. Cl. CPC H04R 9/04; H04R 31/00
USPC 381/400; 29/594

(57) ABSTRACT

An open modular speaker assembly is configured to be inserted into a mobile wireless device and includes a frame, a magnetic assembly that is disposed within the frame and a membrane assembly disposed within the frame and in proximity to the magnetic assembly. Actuation of the magnetic assembly by an electric current causes a movement of the magnetic assembly causing a resultant movement of the membrane assembly. A first portion of the mobile wireless device and the membrane assembly form a front volume where the resultant movement of the membrane assembly produces sound in the front volume, and such that a second portion of the mobile wireless device and the membrane assembly form a back volume that is separated from the front volume by the membrane assembly. Air is displaced or exchanged between the front volume and the back volume.

### CROSS REFERENCE TO RELATED APPLICATION

This patent claims benefit under 35 U.S.C. §119 (e) to United States Provisional Application No. 61/889,254 entitled “Integrated Speaker Assembly” filed Oct. 10, 2013, the content of which is incorporated herein by reference in its entirety.

### TECHNICAL FIELD

This application relates to speaker assemblies and, more specifically, to their construction characteristics and dimensioning.

### BACKGROUND OF THE INVENTION

Various types of microphones and speakers have been used through the years. In these devices, different electrical components are housed together within a housing or assembly. Other types of acoustic devices may include other types of components. These devices may be used in hearing instruments such as hearing aids or in other electronic devices such as cellular phones and computers.

One type of speaker typically includes a coil, a yoke, an armature (or reed), and magnets. An electrical signal applied to the coil and creates a magnetic field within the motor which causes the armature to move. Movement of the armature causes movement of a diaphragm, which creates sound. Together, the magnets, armature, and yoke form a magnetic circuit. The yoke may also serve to hold or support the magnets or other components.

Another type of speaker (dynamic) includes a coil and a diaphragm, which are coupled together. Excitation of the coil directly moves the diaphragm and coil in unison (mimicking the action of a moving piston), causing sound to be produced.

In today's marketplace, smaller and lighter devices are often desired. For example, smaller speakers are often desired in many mobile applications such as tablets, cellular phones and notebook computers. Unfortunately, with the use of the above-mentioned components it is difficult to reduce the size of a speaker beyond a certain size limit. This has often resulted in user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises an exploded perspective view of a speaker assembly according to various embodiments of the present invention;

FIG. 2 comprises a top view of the assembled speaker assembly of FIG. 1 according to various embodiments of the present invention;

FIG. 3 comprises a bottom view of the assembled speaker assembly of FIG. 1 and FIG. 2 according to various embodiments of the present invention;

FIG. 4 comprises a side cutaway view of the speaker assembly of FIG. 1, FIG. 2, and FIG. 3 according to various embodiments of the present invention;

FIG. 5 comprises a perspective top view of a portion of a single speaker assembly according to various embodiments of the present invention;

FIG. 6 comprises a perspective bottom view of the speaker assembly of FIG. 5 according to various embodiments of the present invention;

FIG. 7 comprises perspective top view of the assembled speaker assembly of FIG. 5 and FIG. 6 according to various embodiments of the present invention;

FIG. 8 comprises a perspective view of a three speaker assembly according to various embodiments of the present invention;

FIG. 9 comprises a perspective view of a two speaker assembly (Two way speaker assembly) according to various embodiments of the present invention;

FIG. 10 comprises a top view of a speaker assembly in a device according to various embodiments of the present invention;

FIG. 11 comprises a bottom view of the speaker assembly in the device of FIG. 10 according to various embodiments of the present invention;

FIG. 12 comprises a side perspective view of the speaker assembly in the device of FIG. 10 and FIG. 11 taken along line A-A according to various embodiments of the present invention;

FIG. 13 comprises a side perspective view of the speaker assembly in the device of FIG. 10, FIGS. 11, and 12 taken along line B-B according to various embodiments of the present invention;

FIG. 14 comprises a top view of a speaker assembly in a device according to various embodiments of the present invention;

FIG. 15 comprises a bottom view of the speaker assembly in the device of FIG. 14 according to various embodiments of the present invention;

FIG. 16 comprises a side perspective view of the speaker assembly in the device of FIG. 14 and FIG. 15 taken along line A-A according to various embodiments of the present invention;

FIG. 17 comprises a side perspective view of the speaker assembly in the device of FIG. 14, FIGS. 15, and 16 taken along line B-B according to various embodiments of the present invention;

FIG. 18 comprises a top view of a speaker assembly in a device according to various embodiments of the present invention;

FIG. 19 comprises a bottom view of the speaker assembly in the device of FIG. 18 according to various embodiments of the present invention;

FIG. 20 comprises a side perspective view of the speaker assembly in the device of FIG. 18 and FIG. 19 taken along line A-A according to various embodiments of the present invention;

FIG. 21 comprises a side perspective view of the speaker assembly in the device of FIG. 18, FIGS. 19, and 20 taken along line B-B according to various embodiments of the present invention;

FIG. 22 comprises an exploded perspective view of a two speaker assembly according to various embodiments of the present invention;

FIG. 23 comprises a top perspective view of the assembled speaker assembly of FIG. 22 according to various embodiments of the present invention;

FIG. 24 comprises a bottom perspective view of the speaker assembly of FIGS. 22-23 according to various embodiments of the present invention;

FIG. 25 comprises a side perspective view of the assembled speaker assembly of FIGS. 22-24 according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are described that provide for the modularization of speaker assemblies and utilize an integrated structure. By “integrated structure,” it is meant the combining of one or more components into one structure or system. The approaches allow for the improvement of back venting (e.g., provides the maximum coupling of the air between the diaphragm and the available back volume) in an integrated structure. In another advantage of the present approaches, the internal components of the speaker can be completely tested before being placed into a final assembly or housing structure. The assembly structure may be constructed of a transparent material so that ultraviolet (UV) glue may be used to secure components together. In another advantage, several speakers may also be combined to form a single package. This provides the ability to form a two-way speaker system using a low frequency and high frequency driver (speaker). A plastic frame or assembly (or other mechanical support system) may be provided that uses a cross-over network via discrete components (e.g., capacitors, inductors, resistors) with Laser Direct Structuring (LSD) and Surface Mount Technology (SMT) processing. As used herein, LDS refers to approaches to produce electrical circuit layouts on complex three-dimensional surfaces of carriers or structures. For instance, a laser beam transfers or etches artwork directly from the computer onto the plastic component. SMT refers to approaches for producing electronic circuits where electrical components are mounted or placed directly onto the surface.

The present approaches are described with respect to “speakers,” but could also be applied to “receivers.” Receivers and speakers are in some respects different. While the basic structure and operation is roughly the same, the main difference is the use-case. For a speaker, the distance from the user's ears is several centimeters (approximately 4-12 inches) away. For a receiver, the distance is very close; usually up against the ears. In addition, the diaphragm thickness for a speaker is usually thicker than the receiver. Lastly, the impedance for speakers range from approximately 4-8 ohms, but receivers can be approximately 16 ohms, 32 ohms or higher.

An open modular speaker assembly configured to be inserted into a mobile applications and includes a frame (or mechanical support system or structure); a magnetic assembly that is disposed within the frame; and a membrane assembly disposed within the frame and in proximity to the magnetic assembly. The membrane assembly includes a diaphragm and actuation of the magnetic assembly by an electric current causes a movement of the magnetic assembly causing a resultant movement of the membrane assembly. A first portion of the mobile application device and the membrane assembly form a front volume where the resultant movement of the membrane assembly produces sound in the front volume. A second portion of the mobile application device and the membrane assembly form a back volume that is separated from the front volume by the membrane assembly. Air is displaced or coupled between the diaphragm and an available back volume.

In other aspects, the mobile application may be a personal computer, a notebook computer, a cellular phone, or a tablet. Other examples are possible. The magnetic assembly may include at least one magnet and a coil.

In other examples, the magnetic assembly, membrane assembly, first portion of the mobile application, and second portion of the mobile application form a speaker. The speaker may be a dynamic speaker, an armature speaker, or a piezo-electric speaker. Other examples are possible.

In others of these embodiments, an open modular speaker assembly is configured to be inserted into a mobile application device and includes a frame (or mechanical support system or structure); a cross-over network disposed within the frame; a first magnetic assembly and a second magnetic assembly that are disposed within the frame and coupled to the cross-over network; and a first membrane assembly and a second membrane assembly disposed within the frame. The first magnetic assembly is disposed in proximity to the first membrane assembly, and the second magnetic assembly is disposed in proximity to the second membrane assembly. The first membrane assembly includes a first diaphragm and the second membrane assembly including a second diaphragm.

Actuation of the first magnetic assembly by a first electric current causes a first movement of the first magnetic assembly causing a resultant first movement of the first membrane assembly. Actuation of the second magnetic assembly by a second electric current causes a second movement of the second magnetic assembly causing a resultant second movement of the second membrane assembly. A first portion of the mobile application device, the first membrane assembly, and the second membrane assembly form a front volume where the resultant movement of the first membrane assembly or the second membrane assembly produces sound in the front volume. A second portion of the mobile wireless device, the first membrane assembly, and the second membrane assembly form a back volume that is separated from the front volume by the membrane assembly. Air is displaced or coupled between the first diaphragm and the second diaphragm, and the available back volume, and wherein the cross-over network selectively switches electrical signals between the first magnetic assembly and the second magnetic assembly.

In other aspects, the first magnetic assembly, first membrane assembly, first portion of the mobile wireless device, and second portion of the wireless device form a first speaker. The first speaker may be a dynamic speaker, an armature speaker, or a piezo-electric speaker. Other examples are possible.

The second magnetic assembly, second membrane assembly, first portion of the mobile wireless device, and second portion of the wireless device form a second speaker. The second speaker may be a dynamic speaker, an armature speaker, or a piezo-electric speaker. Other examples are possible.

In others of these embodiments, a mobile wireless device, the mobile wireless device includes a housing; at least one customer electronic device disposed within the housing; and an open modular speaker assembly that is disposed within the housing

The open modular speaker assembly includes a frame (or mechanical support system or structure); a magnetic assembly that is disposed within the frame; and a membrane assembly disposed within the frame and in proximity to the magnetic assembly. Actuation of the magnetic assembly by an electric current causes a movement of the magnetic assembly causing a resultant movement of the membrane assembly. A first portion of the housing and the membrane assembly form a front volume where the resultant movement of the membrane assembly produces sound in the front volume. A second portion of the housing and the membrane assembly form a back volume that is separated from the front volume by the membrane assembly. Air is displaced or coupled between the diaphragm and an available back volume.

In others of these embodiments a mobile wireless device is constructed utilizing a modular and open speaker assembly. The open and modular speaker assembly is obtained and includes a frame, a magnetic assembly that is disposed within the frame, and a membrane assembly disposed within the frame and in proximity to the magnetic assembly.

The open and modular speaker assembly is inserted into the mobile wireless device such that a first portion of the mobile wireless device and the membrane assembly form a front volume where the resultant movement of the membrane assembly produces sound in the front volume. A second portion of the mobile wireless device and the membrane assembly form a back volume that is separated from the front volume by the membrane assembly.

In some aspects, the mobile wireless device is a personal computer, a cellular phone, or a tablet. Other examples are possible.

In some examples, the membrane assembly includes a diaphragm. In other examples, the magnetic assembly comprises at least one magnet and a coil.

In other aspects, the magnetic assembly, membrane assembly, first portion of the mobile wireless device, and second portion of the wireless device form a speaker. The speaker may be a dynamic speaker, an armature speaker, or a piezo-electric speaker. Other examples are possible.

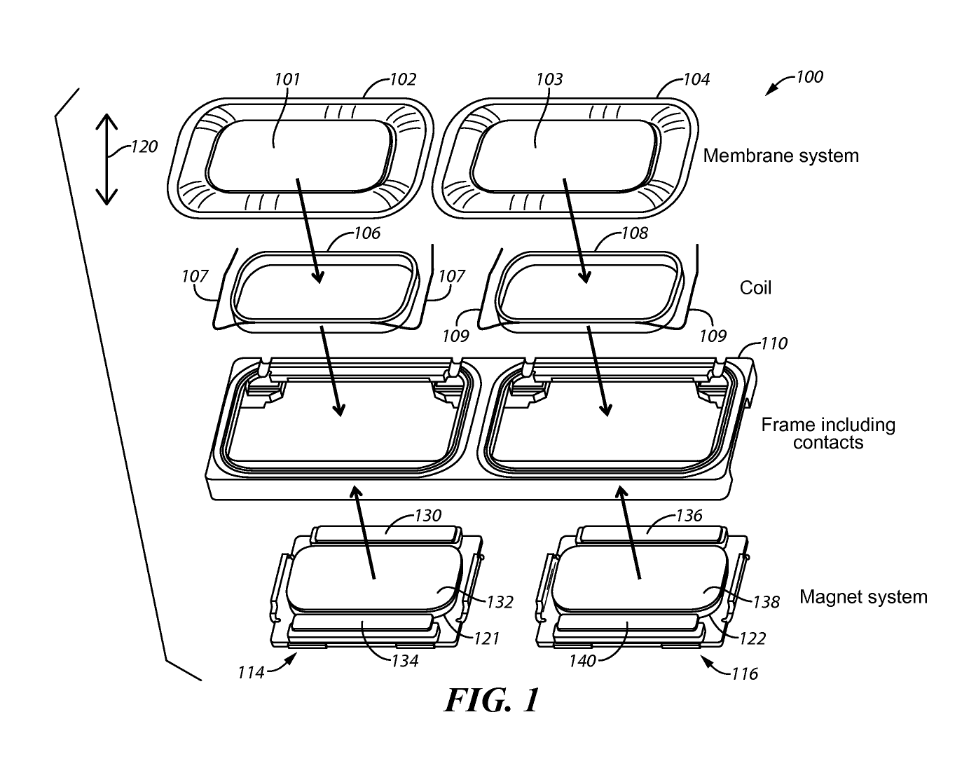

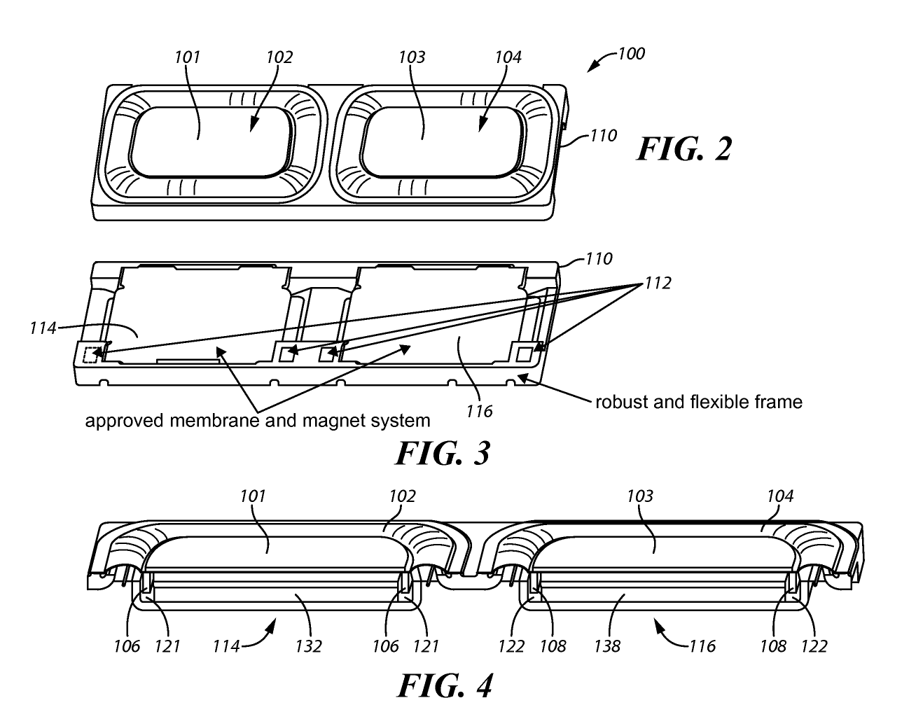

Referring now to FIGS. 1-4, a speaker assembly 100 is described. The assembly 100 is a dual assembly and includes two speakers (receivers or drivers). More specifically, the assembly includes a first membrane apparatus 102 (with a first diaphragm 101) and a second membrane apparatus 104 (with a second diaphragm 103); a first coil 106 (coupled to first wires 107) and a second coil 108 (coupled to second wires 109); a frame 110 (or other mechanical support system or structure) including contacts 112; and a first magnet apparatus 114 (with magnets 130, 132, and 134) and a second magnet apparatus 116 (with magnets 136, 138, and 140). It will be appreciated that instead of the three rectangular shaped magnets shown, round magnets may also be used. Other shapes and configures for the magnetic structure and magnets are possible.

The speakers described with respect to FIGS. 1-4 (and any of the other speakers described herein) can be of a variety of types. The dynamic speaker includes a coil and a diaphragm, which are coupled together. Electrical excitation of the coil, in the presence of a static magnetic field directly moves the diaphragm and coil in unison (mimicking the action of a moving piston), causing sound to be produced.

Another type of speaker (Balanced Armature) includes a coil, a yoke, an armature (or reed), and magnets. An electrical signal applied to the coil and creates a magnetic field within the motor which causes the armature to move. Movement of the armature causes movement of a diaphragm, which creates sound. Together, the magnets, armature, and yoke form a magnetic circuit. The yoke may also serve to hold or support the magnets or other components.

Still another type of speaker that could be utilized is a piezo-electric speaker. Other examples of speakers are possible.

The coils 106 and 108 are fastened to the membrane apparatus 102 and 104, respectively. The coils 106 and 108 are any appropriate electrical wired coil as known in the art. The frame 110 may be constructed of a transparent plastic allowing UV glues to be used to secure it to other components.

The first membrane apparatus 102 and second membrane apparatus include rings to which the first diaphragm 101 and the second diaphragm 103 are attached. The first magnet apparatus 114 includes a slot 121 in which the first coil 106 is disposed, while the second magnet apparatus 116 includes a slot 122 in which the second coil 108 is disposed when assembled. The pads 112 provide electrical contacts from the electronic device (in which the assembly 100 is disposed) to the wires 107 and 109.

The assembly 100 is inserted into an appropriate electronic device such as a cellular phone or a personal computer. The structure of the electronic device forms a front volume and a back volume. Excitation of the coils 102 and 104 (by applying an electrical signal in the wires 107 and 109) causes the coil/membrane apparatus to move upward or downward in either direction indicated by the arrow labeled 120 in a piston-like actuation. This movement produces sound, which can be presented to the user of the electronic device.

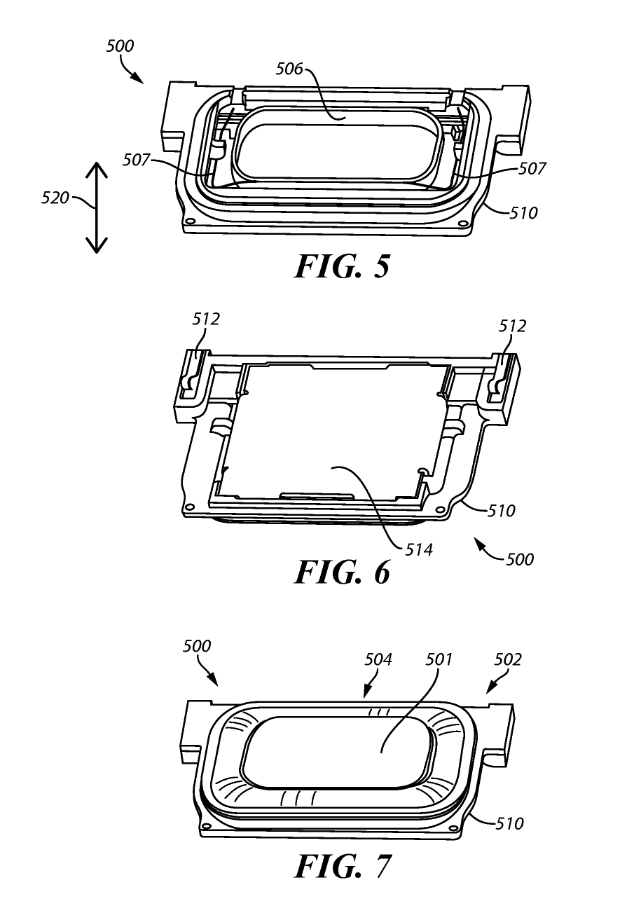

Referring now to FIGS. 5-7, a speaker assembly 500 is described. The assembly 500 includes a single speaker (receiver or driver). The speaker assembly 500 is identical to a single one of the speakers in the assembly 100 described above and like numbered components are the same as previously described. The assembly 500 includes a membrane apparatus 502 (with a diaphragm 501); a coil 506 (coupled to first wires 507); a frame 510 including contacts 512; and a magnet apparatus 514 (including magnets that are not shown in these figures).

The coil 506 is fastened to the membrane apparatus 502. The coil 506 is any appropriate electrical wired coil as known in the art. The frame 510 may be constructed of a transparent plastic allowing UV glue to be used to secure it to other components.

The membrane apparatus 502 includes rings to which the diaphragm 501. The magnet apparatus 514 includes a slot (not shown) in which the coil 516 is disposed. The pads 512 provide electrical contacts from the electronic device (in which the assembly 500 is disposed) to the wires 507.

The assembly 500 is inserted into an appropriate electronic device such as a cellular phone or a personal computer. The structure of the electronic device forms a front volume and a back volume. Excitation of the coil 502 (by applying an electrical signal in the wires 507) causes the coil/membrane apparatus to move upward or downward in either direction indicated by the arrow labeled 520 in a piston-like actuation. This movement produces sound, which can be presented to the user of the electronic device.

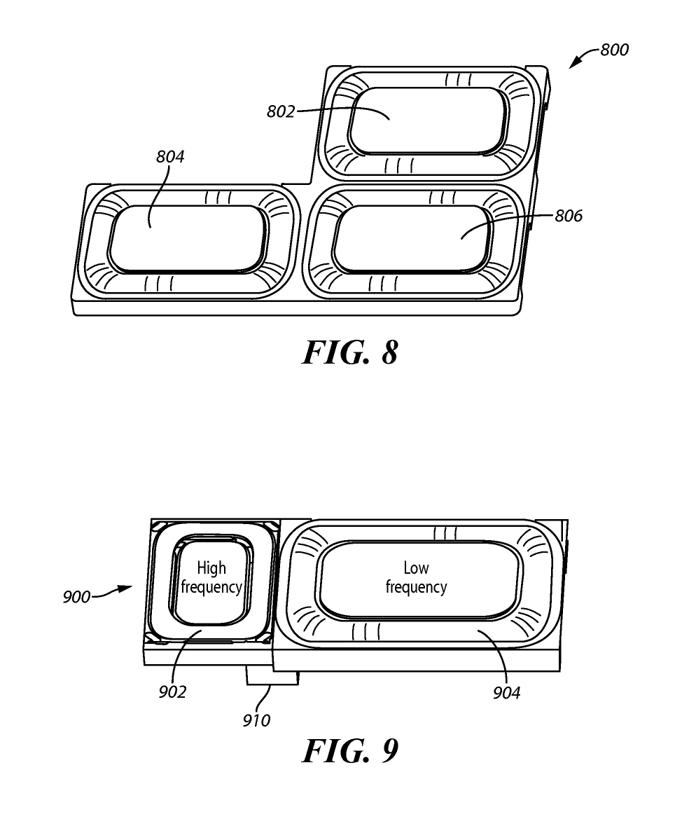

Referring now to FIG. 8, a three speaker assembly 800 is described. The assembly 800 includes a first speaker 802, a second speaker 804, and a third speaker 806. The assembly 800 may be inserted into any appropriate electronic device such as a cellular phone or a personal computer. The speakers 802, 804, and 806 convert electrical signals into sound energy when placed in the electronic device. The speakers 802, 804, and 806 may be structured as indicated in any of the examples given with respect to FIGS. 1-7 and may be coupled to a cross-over network to filter specific frequencies to specific speakers.

Referring now to FIG. 9, a two way speaker assembly 900 is described. The assembly 900 includes a first speaker 902 and a second speaker 904. The assembly 900 may be inserted into any appropriate electronic device such as a cellular phone or a personal computer. The speakers 902 and 904 convert electrical signals into sound energy when placed in the electronic device. The speakers 902 and 904 may be structured as indicated in any of the examples described above with respect to FIGS. 1-7. The speaker 902 may be a high frequency speaker or driver and the speaker 904 may be a low frequency speaker or driver. A cross-over network (Based on LDS and SMT processing) 910 may switch signals between the speaker 902 and the speaker 904 (i.e., electrical signals representing high frequency signals are routed to the speaker 902, while electrical signals representing low frequency signals are routed to the speaker 904).

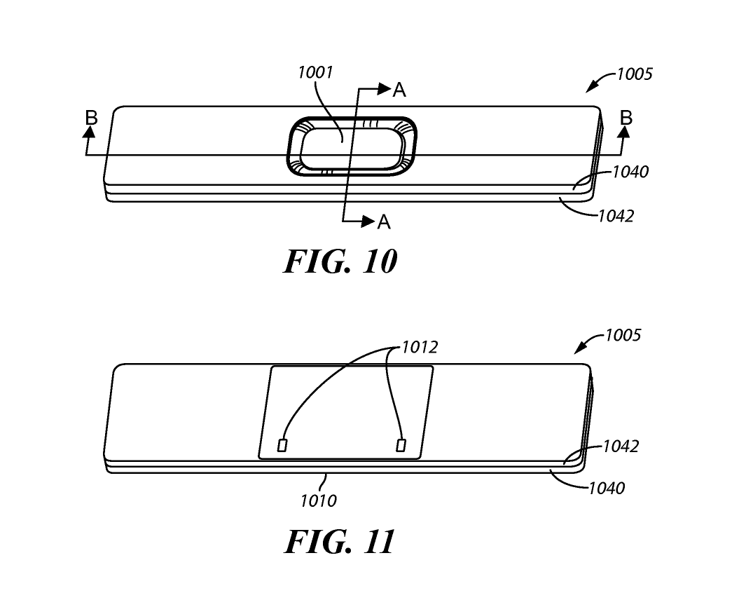

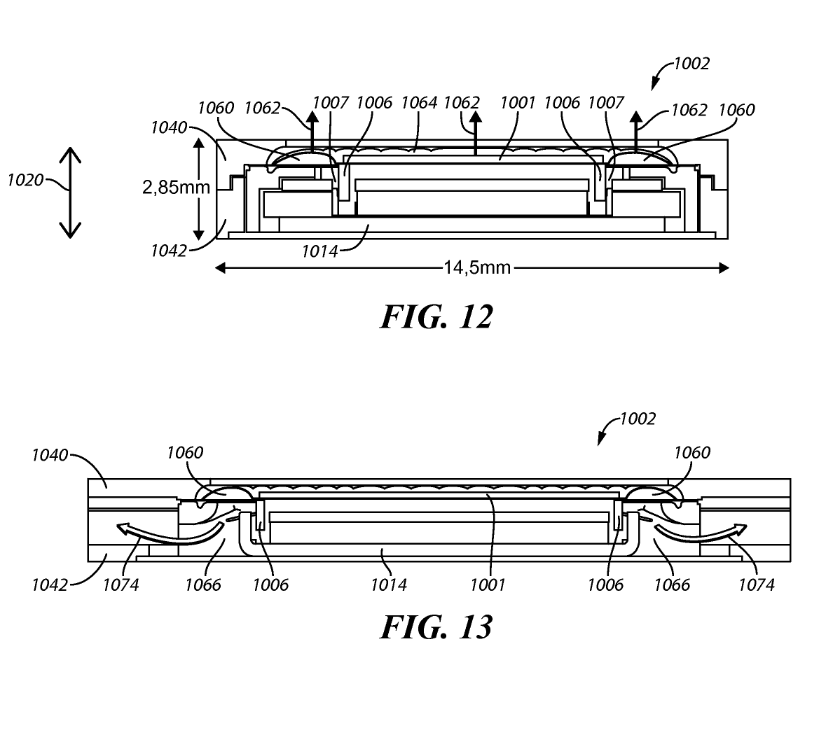

Referring now to FIGS. 10-13 a speaker assembly 1000 disposed in a device 1005 is described. The assembly 1000 includes a single speaker (driver). The speaker assembly 1000 is similar to or identical to a single one of the speakers in the assembly 500 described above and like numbered components are the same as previously described above. The assembly 1000 includes a membrane apparatus 1002 (with a diaphragm 1001); a coil 1006 (coupled to first wires 1007); a frame 1010 including contacts 1012; and a magnet apparatus 1014 (including magnets that are not shown in this figure). The device 1005 includes a top housing 1040 and a bottom housing 1042. Ports 1060 are formed extend through the top of the device 1005 allowing sound to exit.

The coil 1006 is fastened to the membrane apparatus 502. The coil 1006 is any appropriate electrical wired coil as known in the art. The frame 1010 may be constructed of a transparent plastic allowing UV glue to be used.

The membrane apparatus 1002 includes rings to which the diaphragm 1001 is attached. The magnet apparatus 1014 includes a slot (not shown) in which the coil 1006 is disposed. The pads 1012 provide electrical contacts from the electronic device (in which the assembly 1000 is disposed) to the wires 1007. It will be appreciated that in this example the electronic device 1005 is approximately 3.36 mm high and 15.3 mm wide. Other dimensions are possible.

The assembly 1000 is inserted (e.g., glued ultrasonic welded, snapped, to mention a few examples) into a case 1040 and 1042 (e.g., plastic or metal housing including possible internal electronic components). The assembly structure 1000 including the optimized amount of back volume 1066 and back venting 1074 create a modular assembly 1005, which can be mounted into electronic device 1005 such as a cellular phone or personal computer. Other examples of electronic devices are possible. The structure of the electronic device 1005 (including its housing and possibly internal electronic components) and the assembly 1000 forms a front volume 1064 and a back volume 1066. Excitation of the coil 1002 (by applying an electrical signal in the wires 1007) causes the coil/membrane apparatus to move upward or downward in either direction indicated by the arrow labeled 1020 and this allows sound 1062 to exit the device. Venting 1074 occurs as air moves into the back volume 1066 from the membrane apparatus 1002 (with a diaphragm 1001). Air may be exchanged between the front volume and back volume. It will be appreciated that sounds exits through the top of the device 1005. By “front volume,” it is meant the space where sound is created by moving the membrane apparatus. The membrane apparatus typically separates the front volume from the back volume.

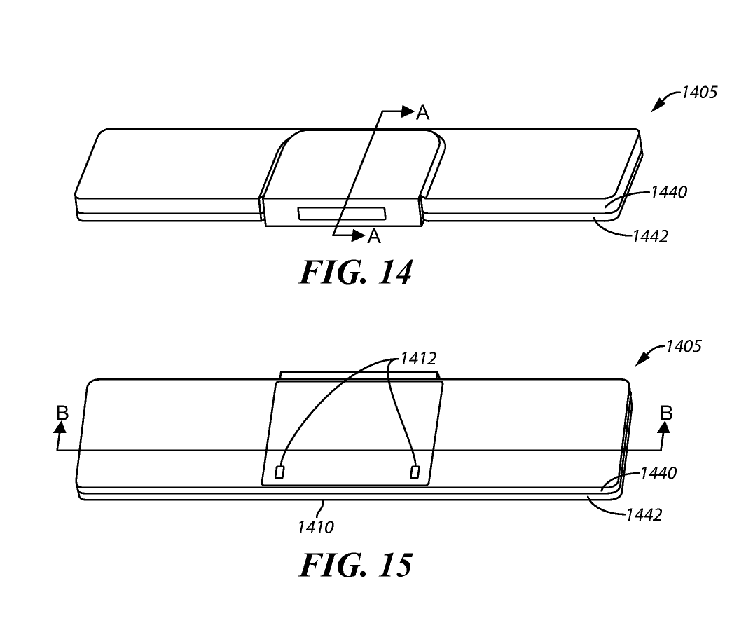

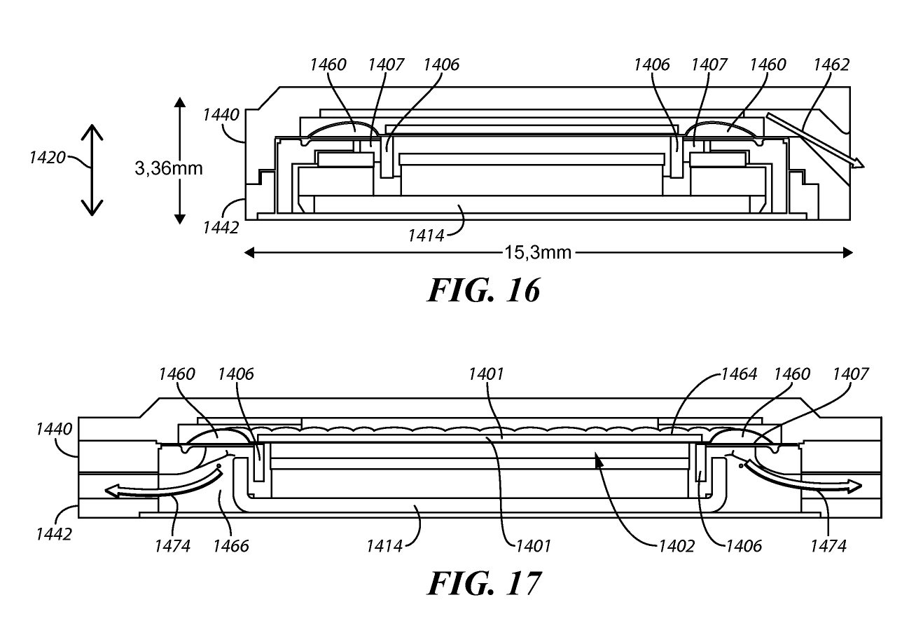

Referring now to FIGS. 14-17 a speaker assembly in a device is described. The assembly 1400 includes a single speaker (receiver). The speaker assembly 1400 is similar to or identical to a single one of the speakers in the assembly 1400 described above and like numbered components are the same as previously described. The assembly 1400 includes a membrane apparatus 1402 (with a diaphragm 1401); a coil 1406 (coupled to wires 1407); a frame 1410 including contacts 1412; and a magnet apparatus 1414 (including magnets that are not shown in this figure). The device 1405 includes a top housing 1440 and a bottom housing 1442. A port 1460 extends through the side of the device 1405 and allows sound to exit.

The coil 1406 is fastened to the membrane apparatus 1402. The coil 1406 is any appropriate electrical wired coil as known in the art. The frame 1410 may be constructed of a transparent plastic allowing UV glue to be used to secure it to other components.

The membrane apparatus 1402 includes rings to which the diaphragm 1401 is attached. The magnet apparatus 1414 includes a slot in which the coil 1406 is disposed. The pads 1412 provide electrical contacts from the electronic device (in which the assembly 1400 is disposed) to the wires 1407. It will be appreciated that in this example the electronic device 1405 is approximately 3.36 mm high and 15.3 mm wide. Other dimensions are possible.

The assembly 1400 is inserted (e.g., glued ultrasonic welded, snapped, to mention a few examples) into a case 1440 and 1442 (e.g., plastic or metal housing including possible internal electronic components). The assembly structure 1400 including the optimized amount of back volume 1466 and back venting 1474 create a modular assembly 1405, which can be mounted into electronic device 1405 such as a cellular phone or personal computer. Other examples of electronic devices are possible. The structure of the electronic device 1405 together with the assembly 1400 forms a front volume 1464 and a back volume 1466. The membrane apparatus is fully covered/protected and the sound outlet is at the side (side porting is provided). Excitation of the coil 1406 (by applying an electrical signal in the wires 1407) causes the coil/membrane apparatus to move upward or downward in either direction indicated by the arrow labeled 1420 and this allows sound 1462 to exit the device. Venting 1474 occurs as air moves through the back volume 1466 and/or from the membrane apparatus 1402 into the back volume 1066. Air may be exchanged between the front volume and back volume. It will be appreciated that sounds exits through the top of the device 1405.

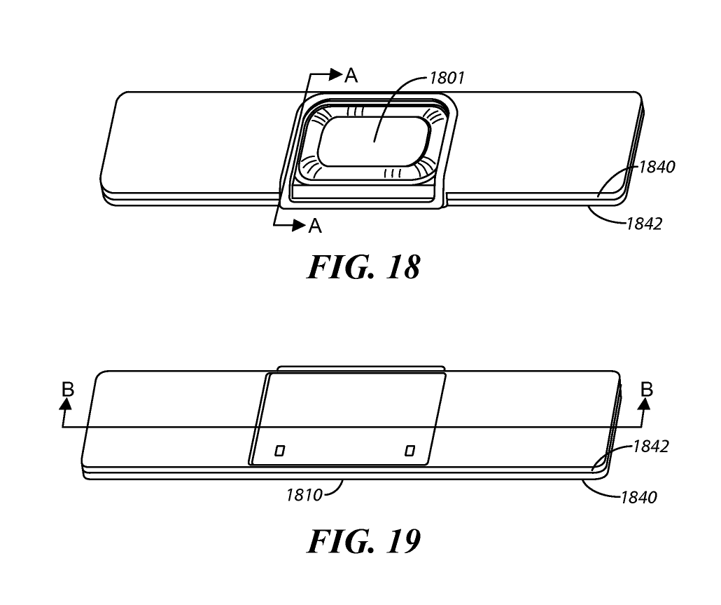

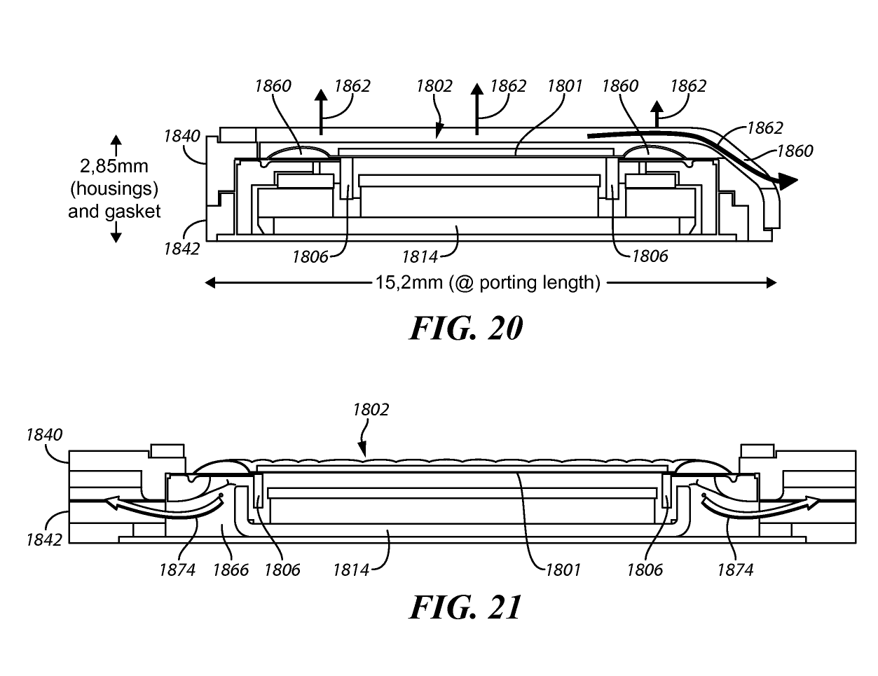

Referring now to FIGS. 18-21 a speaker assembly 1800 in a device 1805 is described. The assembly 1800 includes a single speaker (receiver). The speaker assembly 1800 is similar to or identical to a single one of the speakers in the assembly 500 described above and like numbered components are the same as previously described. The assembly 1800 includes a membrane apparatus 1802 (with a diaphragm 1801); a coil 1806 (coupled to wires 1807); a frame 1810 including contacts 1812; and a magnet apparatus 1814 (including magnets that are not shown in this figure). The device 1805 includes a top housing 1840 and a bottom housing 1842. Ports 1860 extend through both the side and top of the device 1805.

The coil 1806 is fastened to the membrane apparatus 1802. The coil 1806 is any appropriate electrical wired coil as known in the art. The frame 1810 may be constructed of a transparent plastic allowing UV glue to be used to secure it to other components.

The membrane apparatus 1802 includes rings to which the diaphragm 1801 is attached. The magnet apparatus 1814 includes a slot in which the coil 1806 is disposed. The pads 1812 provide electrical contacts from the electronic device 1805 in which the assembly 1800 is disposed to the wires 1807. It will be appreciated that in this example the electronic device 1805 is approximately 2.85 mm high and 15.2 mm wide. Other dimensions are possible.

The assembly 1800 is inserted into the electronic device 1805 such as a cellular phone or a personal computer. Other examples of electronic devices are possible. The structure of the electronic device 1805 and the assembly 1800 forms a front volume 1864 and a back volume 1866. Excitation of the coil 1806 (by applying an electrical signal in the wires 1807) causes the coil/membrane apparatus to move upward or downward in either direction indicated by the arrow labeled 1820 and this allows sound 1862 to exit the device 1805. Venting 1874 occurs as air moves through the back volume 1866. It will be appreciated that sounds exits through both the top and the side of the device 1805.

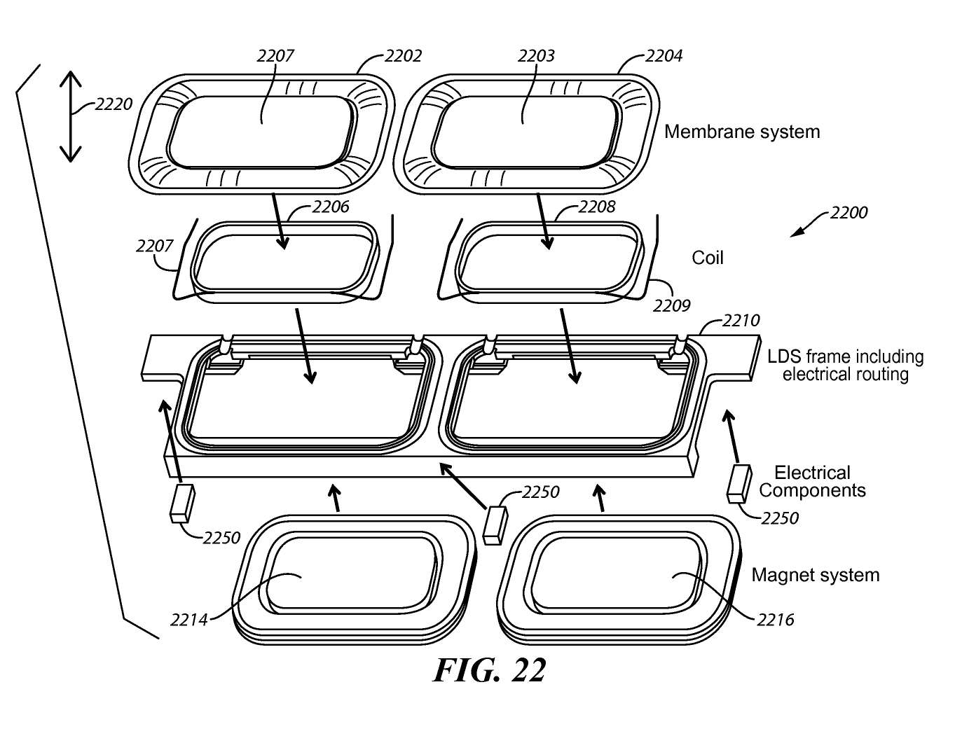

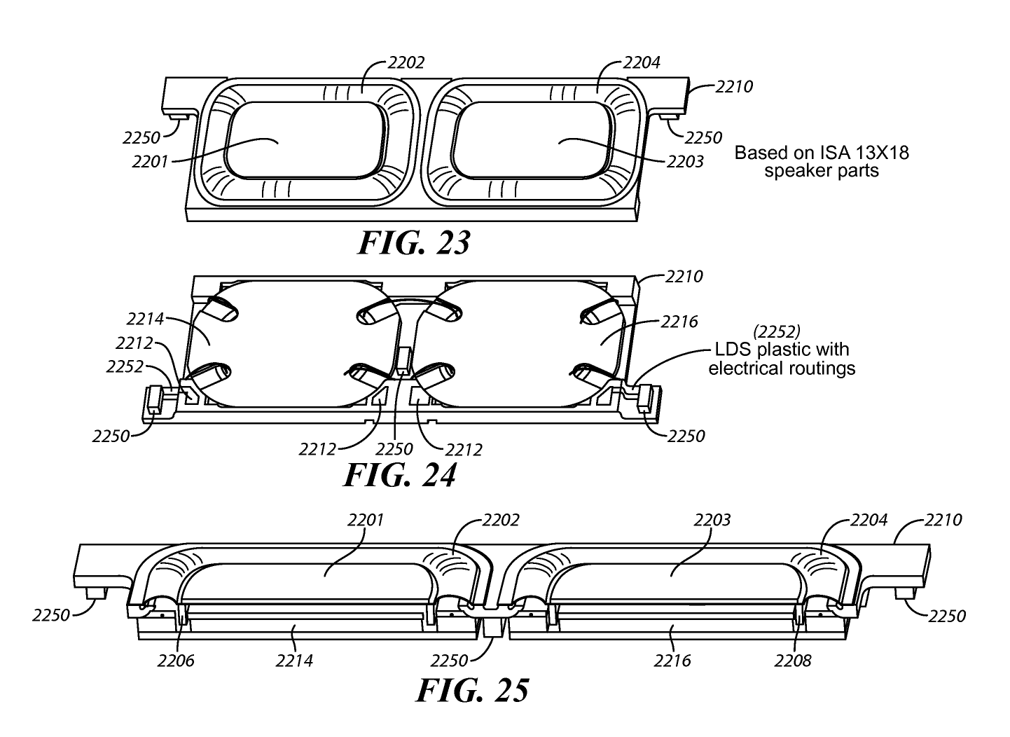

Referring now to FIGS. 22-25, another example of an assembly 2200 is described and like numbered elements in FIGS. 22-25 correspond to like-numbered elements in FIGS. 1-4. More specifically, the assembly includes a first membrane apparatus 2202 (with a first diaphragm 2201) and a second membrane apparatus 2204 (with a second diaphragm 2203); a first coil 2206 (coupled to first wires 2207) and a second coil 2208 (coupled to second wires 2209); a frame 2210 including contacts 2212; and a first magnet apparatus 2214 and a second magnet apparatus 2216. It will be appreciated that instead of the three rectangular shaped magnets shown, round magnets may also be used. Other shapes and configures for the magnetic structure and magnets are possible. The assembly 2200 also includes electrical components 2250, which could be a variety of devices such as resistors, capacitors, or integrated circuits to mention only a few examples. LDS plastic with electrical routings 2252 couples the first magnet apparatus 2214 and second magnetic apparatus 2216 to ones of the electrical components.

It will be appreciated that the speaker assemblies described herein can be disposed in a variety of different electronic devices. These electronic devices may have various dimensions, shapes, and configurations. Consequently, it will be understood here that the exact shapes, dimensions, sizes, and configurations of the components of the assembly as well as the front volume and back volume may vary.

It will be understood that one advantage of the present approaches is that it allows thin speaker assemblies to be constructed allowing the speaker assembly to be placed into very thin devices such as cellular phones, personal computers, and personal digital assistants. However, the dimensions, layout, and configurations of the speaker assemblies described herein can be modified to be fit into devices having any types or values of dimensions.

The present approaches provide a speaker frame that is both a mechanical and electrical system. The mechanical aspects and advantages of the frame provide a secure support the speaker structure. The electrical aspects and advantages of the frame provide electrical connections to the speaker box and allow the ability to add LDS based circuits to the housing to provide crossover networks (e.g., two way, three way speakers), Electrical circuits for RF protection, in addition an LDS and or insert molded antennas that are unrelated to the speaker's function can be included.

The present approaches allow for improved SPL performance (e.g., louder acoustic performance) due to the improved back venting relative to a discrete speaker. The ISA (Integrated Speaker Assembly) provided herein can be completely tested before being placed into the final resting location of the speaker box. The test system will provide a fixed back volume that is required to test the ISA as a discrete speaker. It will be appreciated that the present approaches provide hybrid designs where the ISA provides the capability for high volume assembly, modularity, reuse and the testability of a discrete speaker, with the performance of an integrated speaker. This allows the user the benefits of both a discrete and integrated speaker. The assemblies provided herein can be fabricated using tight tolerance molding processes to enable precision placement.

The present approaches can be used to integrate tight tolerance assembly features into the plastic housing that can be disposable after assembly. The Membrane, Coil and Magnet subassemblies (see FIG. 1) can be assembled with tight tolerance tooling that is molded at the same time of the speaker frame (element 110). These features will allow the insertion of the coil (108), the membrane system (100), and the magnet system (116). This eliminates the need for using separate tooling to complete the speaker assembly process. This unique feature prevents the tolerance stack-up issues typically found with tooling manufactured with traditional approaches.

The assemblies provided herein allow for flexible placement of the spring contacts. The contacts can be insert molded, created via LDS, or both insert molded with LDS.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An open modular speaker assembly, the open modular speaker assembly configured to be inserted into a mobile applications, the open modular speaker assembly comprising:
a frame;
a magnetic assembly that is disposed within the frame;
a membrane assembly disposed within the frame and in proximity to the magnetic assembly, the membrane assembly including a diaphragm; such that actuation of the magnetic assembly by an electric current causes a movement of the magnetic assembly causing a resultant movement of the membrane assembly;
such that a first portion of the mobile application device and the membrane assembly form a front volume where the resultant movement of the membrane assembly produces sound in the front volume, and such that a second portion of the mobile application device and the membrane assembly form a back volume that is separated from the front volume by the membrane assembly;
wherein air is displaced or coupled between the diaphragm and an available back volume.

2. The open modular speaker assembly of claim 1, wherein the mobile application is a personal computer, a notebook computer, a cellular phone, or a tablet.

3. The open modular speaker assembly of claim 1 wherein the magnetic assembly comprises at least one magnet and a coil.

4. The open modular speaker assembly of claim 1, wherein the magnetic assembly, membrane assembly, first portion of the mobile application, and second portion of the mobile application form a speaker, the speaker selected from the group consisting of a dynamic speaker, an armature speaker, or a piezo-electric speaker.

5. An open modular speaker assembly, the open modular speaker assembly configured to be inserted into a mobile application device, the open modular speaker assembly comprising:
a frame;
a cross-over network disposed within the frame;
a first magnetic assembly and a second magnetic assembly that are disposed within the frame and coupled to the cross-over network;
a first membrane assembly and a second membrane assembly disposed within the frame, the first magnetic assembly being disposed in proximity to the first membrane assembly, and the second magnetic assembly being disposed in proximity to the second membrane assembly, the first membrane assembly including a first diaphragm and the second membrane assembly including a second diaphragm;
such that actuation of the first magnetic assembly by a first electric current causes a first movement of the first magnetic assembly causing a resultant first movement of the first membrane assembly;
such that actuation of the second magnetic assembly by a second electric current causes a second movement of the second magnetic assembly causing a resultant second movement of the second membrane assembly;
such that a first portion of the mobile application device, the first membrane assembly, and the second membrane assembly form a front volume where the resultant movement of the first membrane assembly or the second membrane assembly produces sound in the front volume, and such that a second portion of the mobile wireless device, the first membrane assembly, and the second membrane assembly form a back volume that is separated from the front volume by the membrane assembly;
wherein air is displaced or coupled between the first diaphragm and the second diaphragm, and the available back volume, and wherein the cross-over network selectively switches electrical signals between the first magnetic assembly and the second magnetic assembly.

6. The open modular speaker assembly of claim 5, wherein the mobile application is a personal computer, notebook computer, a cellular phone, or a tablet.

7. The open modular speaker assembly of claim 5, wherein the first magnetic assembly and the second magnetic assembly each comprise at least one magnet and a coil.

8. The open modular speaker assembly of claim 5 wherein the first magnetic assembly, first membrane assembly, first portion of the mobile wireless device, and second portion of the wireless device form a first speaker, the first speaker selected from the group consisting of a dynamic speaker, an armature speaker, or a piezo-electric speaker.

9. The open modular speaker assembly of claim 8 wherein the second magnetic assembly, second membrane assembly, first portion of the mobile wireless device, and second portion of the wireless device form a second speaker, the second speaker selected from the group consisting of a dynamic speaker, an armature speaker, or a piezo-electric speaker.

10. A mobile wireless device, the mobile wireless device comprising:
a housing;
at least one customer electronic device disposed within the housing;
an open modular speaker assembly that is disposed within the housing, the open modular speaker assembly comprising:
a frame;
a magnetic assembly that is disposed within the frame;
a membrane assembly disposed within the frame and in proximity to the magnetic assembly;
such that actuation of the magnetic assembly by an electric current causes a movement of the magnetic assembly causing a resultant movement of the membrane assembly;
such that a first portion of the housing and the membrane assembly form a front volume where the resultant movement of the membrane assembly produces sound in the front volume, and such that a second portion of the housing and the membrane assembly form a back volume that is separated from the front volume by the membrane assembly;
wherein air is displaced or coupled between the diaphragm and an available back volume.

11. The mobile wireless device of claim 10, wherein the mobile wireless device is a personal computer, a cellular phone, or a tablet.

12. The mobile wireless device of claim 10 wherein the magnetic assembly comprises at least one magnet and a coil.

13. The mobile wireless device of claim 10, wherein the magnetic assembly, membrane assembly, first portion of the mobile wireless device, and second portion of the wireless device form a speaker, the speaker selected from the group consisting of a dynamic speaker, an armature speaker, or a piezo-electric speaker.

14. A method of constructing a mobile wireless device utilizing a modular and open speaker assembly, the method comprising:
obtaining the open and modular speaker assembly, the open and modular speaker assembly comprising a frame, a magnetic assembly that is disposed within the frame, and a membrane assembly disposed within the frame and in proximity to the magnetic assembly;
inserting the open and modular speaker assembly into the mobile wireless device such that a first portion of the mobile wireless device and the membrane assembly form a front volume where the resultant movement of the membrane assembly produces sound in the front volume, and such that a second portion of the mobile wireless device and the membrane assembly form a back volume that is separated from the front volume by the membrane assembly.

15. The method of claim 14, wherein the mobile wireless device is a personal computer, a cellular phone, or a tablet.

16. The method of claim 14, wherein the membrane assembly comprises a diaphragm.

17. The method of claim 14 wherein the magnetic assembly comprises at least one magnet and a coil.

18. The method of claim 14, wherein the magnetic assembly, membrane assembly, first portion of the mobile wireless device, and second portion of the wireless device form a speaker, the speaker selected from the group consisting of a dynamic speaker, an armature speaker, or a piezo-electric speaker.
